(19) United States
(12) Patent Application Publication
(10) Pub. No.: US 2006/0215491 A1
(43) Pub. Date: Sep. 28, 2006

(54) System and method for transmitting information through a fluid medium

(76) Inventor: Brent S. Hall, Cheshire, CT (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 11/085,306

(22) Filed: Mar. 21, 2005

(51) Int. Cl. H04H 9/00

(52) U.S. Cl. 367/83

(57) ABSTRACT

A preferred method for transmitting digital information through a fluid medium includes generating a first and a second pressure pulse in the fluid medium, and encoding the digital information in the second pressure pulse by generating the second pressure pulse a predetermined amount of time after generating the first pressure pulse. The preferred method also includes sensing the first and the second pressure pulses, and decoding the digital information by determining the elapsed time between the first pressure pulse and the second pressure pulse.

### FIELD OF THE INVENTION

The present invention relates to underground drilling. More specifically, the invention relates to a system and a method for transmitting information to the surface from a down-hole location in a bore using, for example, mud-pulse telemetry.

### BACKGROUND OF THE INVENTION

Underground drilling, such as gas, oil, or geothermal drilling, generally involves drilling a bore through a formation deep in the earth. Such bores are formed by connecting a drill bit to long sections of pipe, referred to as “drill pipe” or “drill collar,” so as to form an assembly known as a “drill string.” The drill string extends from the surface to the bottom of the bore.

The drill bit is rotated so that the drill bit advances into the earth, thereby forming the bore. In rotary drilling, the drill bit is rotated by rotating the drill string at the surface. Piston-operated pumps on the surface pump high-pressure fluid, referred to as “drilling mud,” through an internal passage in the drill string and out through the drill bit. The drilling mud lubricates the drill bit, and flushes cuttings from the path of the drill bit. The drilling mud then flows to the surface through an annular passage formed between the drill string and the surface of the bore.

The down-hole end of a drill string, which includes the drill bit, is referred to as the “bottom hole assembly.” In “measurement while drilling” (MWD) operations, a sensing module in the bottom hole assembly provide information concerning the direction of the drilling. This information can be used, for example, to control the direction in which the drill bit advances in a steerable drill string. The sensing module in such an application may include a magnetometer to sense azimuth, and accelerometers to sense inclination and tool face.

Historically, information concerning the conditions in the bore, such as information about the formation being drill through, was obtained by stopping the drilling operation, removing the drill string, and lowering sensors into the bore using a wire line cable. The sensors were retrieved after the measurements had been obtained. This approach is known as wire line logging.

More recently, sensing modules have been incorporated into the bottom hole assembly. The sensing modules can provide the drill operator with essentially real time information concerning one or more aspects of the drilling operation as the drilling progresses. In “logging while drilling” (LWD) operations, information is supplied concerning characteristics of the earthen formation being drilled. For example, resistivity sensors may transmit, and then receive, high frequency electromagnetic waves that travel through the formation surrounding the sensor. Information concerning the nature of the formation through which the signal traveled, such as whether the formation contains water or hydrocarbons, can be inferred by comparing the transmitted and received signals. Other types of sensors are used in conjunction with magnetic resonance imaging (MRI). Still other types of sensors include gamma scintillators, which are used to determine the natural radioactivity of the formation, and nuclear detectors, which are used to determine the porosity and density of the formation.

In both LWD and MWD systems, the information collected by the sensors must be transmitted to the surface for analysis. Such data transmission typically is accomplished using a technique referred to as “mud-pulse telemetry.” In a mud-pulse telemetry system, signals from the sensor modules typically are received and digitally encoded in a microprocessor-based data encoder of the bottom hole assembly.

The output of the encoder can be transmitted to a pulser. The pulser forms part of the bottom hole assembly, and generates pressure pulses in the drilling mud in response to the output of the encoder. The pulser can generate the pulses by intermittently restricting the flow area of the drilling mud so as to back pressure the column of drilling mud located up-hole thereof.

The digitally-encoded information generated by the encoder is incorporated in the pulses. The pulses can be defined by a variety of characteristics, including amplitude (the difference between the maximum and minimum values of the pressure), duration (the time interval during which the pressure is increased), shape, and frequency (the number of pulses per unit time or, conversely, the time between pulses).

Various encoding systems have been developed using one or more pressure pulse characteristics to represent binary data, i.e., the binary digits 1 or 0. For example, a pulse of 0.5 second duration can be designated as representing the binary digit 1. A pulse of 1.0-second duration can be designated as representing the binary digit 0.

The pulses travel up the column of drilling mud flowing down to the drill bit, and are sensed by a pressure transducer located at or near the surface. The data from the pressure transducer is then decoded and analyzed electronically by the surface receiver, and the resulting information can be analyzed by the personnel operating the drilling rig, or other users.

Noise, i.e., spurious pulses not commanded by the encoder, can occur during transmission of the encoded data to the surface. Moreover, pulses can be missing from a predetermined sequence of data, or can be attenuated to an extent so as to be undetectable by the pressure transducer. Spurious, missing, or attenuated pulses can result from factors such as oscillations in the supply pressure of the drilling mud, vibrations resulting from the drilling operation, etc. Missing or attenuated pulses also can result when the pulser does not sufficiently block the flow or drilling mud so as to provide the requisite back pressure needed to produce a detectable pulse.

Noise, and missing or attenuated pulses can reduce the accuracy of the data transmitted to the surface. In extreme cases, the data can be corrupted to such an extent as to adversely affect the drilling operations. For example, directional data corrupted by the transmission process during MWD operations can adversely affect the ability of the operators of the drilling rig to guide the drill bit along its desired or required course. Similarly, geologic information corrupted by the transmission process during LWD operations can adversely affect the ability of the drilling rig operators to identify the characteristics of the earthen formation being drilled.

It is therefore desirable to provide a mud-pulse telemetry system that can recognize noise and missing or attenuated pulses, and furnish an indication of such faults to the users of the transmitted information.

### SUMMARY OF THE INVENTION

A preferred method for transmitting information using mud-pulse telemetry comprises generating a time base comprising a plurality of time increments, generating a first and a second pressure pulse at a first location in a column of drilling mud, counting the number of the time increments, detecting the first and second pressure pulses at a second location in the column of drilling mud, and correlating the second pressure pulse with a numerical value based on the number of the time increments that elapse between the detection of the first and the second pressure pulses.

A preferred method for transmitting digital information through a fluid medium comprises generating a first and a second pressure pulse in the fluid medium, and encoding the digital information in the second pressure pulse by generating the second pressure pulse a predetermined amount of time after generating the first pressure pulse. The preferred method also comprises sensing the first and the second pressure pulses, and decoding the digital information by determining the elapsed time between the first pressure pulse and the second pressure pulse.

A preferred method for sending information through a fluid medium comprises generating a succession of pressure pulses in the fluid medium, and timing the pressure pulses so that successive ones of the pressure pulses are spaced apart by respective predetermined time intervals. The preferred method also comprises detecting the pressure pulses, and determining a digital value corresponding to each of the pressure pulses based on the predetermined time interval between the pressure pulse and the previous pressure pulse, and the digital value of the previous pulse.

A preferred embodiment of a system for transmitting information using mud-pulse telemetry comprises an encoder comprising a processor, a memory-storage device communicatively coupled to the processor, and a set of computer-executable instructions stored on the memory-storage device. The encoder generates a time base comprising a plurality of time increments.

The system also comprises a pulser communicatively coupled to the encoder for generating a first and a second pressure pulse at a first location in a column of drilling mud in response to inputs from the encoder, a sensor for detecting the first and the second pressure pulses at a second location in the column of drilling mud.

The system also comprises a decoder communicatively coupled to the sensor and comprising a processor, a memory-storage device communicatively coupled to the processor, and a set of computer-executable instructions stored on the memory-storage device. The decoder counts the number of the time increments and correlates the second pressure pulse with a numerical value based on the number of the time increments that elapse between the detection of the first and the second pressure pulses.

### BRIEF DESCRIPTION OF THE DRAWINGS

The foregoing summary, as well as the following detailed description of a preferred embodiment, are better understood when read in conjunction with the appended diagrammatic drawings. For the purpose of illustrating the invention, the drawings show an embodiment that is presently preferred. The invention is not limited, however, to the specific instrumentalities disclosed in the drawings. In the drawings:

FIG. 1 is a side view of a drill string incorporating a preferred embodiment of a mud-pulse telemetry system, depicting the drill string in a bore formed by the drill string;

FIG. 2 is a magnified view of the area designated “A” in FIG. 1, depicting a drill collar of the drill string in longitudinal cross-section;

FIG. 3 is a cross-sectional view taken through the line “B-B” of FIG. 2;

FIG. 4 is a block diagram of the mud-pulse telemetry system shown in FIGS. 1-3; and

FIGS. 5-8 are a graphical representations of a time base and pressure pulses generated by the mud-pulse telemetry system shown in FIGS. 1-3.

### DETAILED DESCRIPTION OF ILLUSTRATIVE EMBODIMENTS

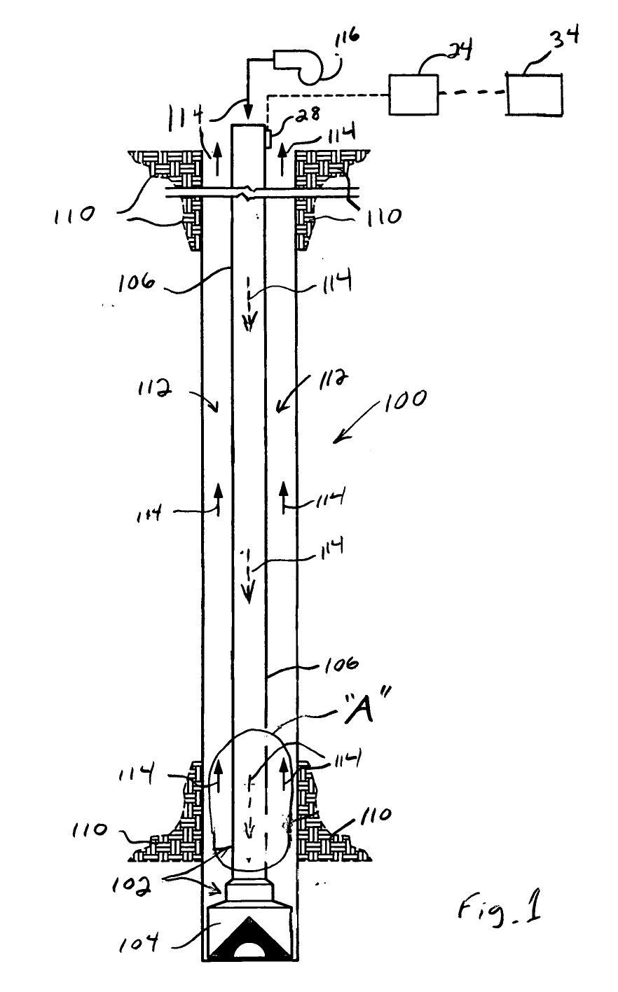

FIG. 1 depicts a drill string 100 comprising a bottom hole assembly 102. The bottom hole assembly 102 forms the down-hole end of the drill string 100, and includes a drill bit 104. The drill bit 104 is mechanically coupled to a drill collar 106 so that the drill bit 104 rotates with the drill collar 106.

The drill collar 106 is rotated by a drilling rig (not shown) located on the surface. Drilling torque is transmitted from the drilling rig to the drill bit 104 by the drill collar 106. The rotating drill bit 104 advances into an earth formation 110, thereby forming a bore 112.

Drilling mud 114 is pumped from the surface, through the drill collar 106, and out of the drill bit 104. The drilling mud 114 is circulated by a pump 116 located on the surface. The drilling mud 114, upon exiting the drill bit 104, returns to the surface by way of an annular passage formed between the drill collar 106 and the surface of the bore 112.

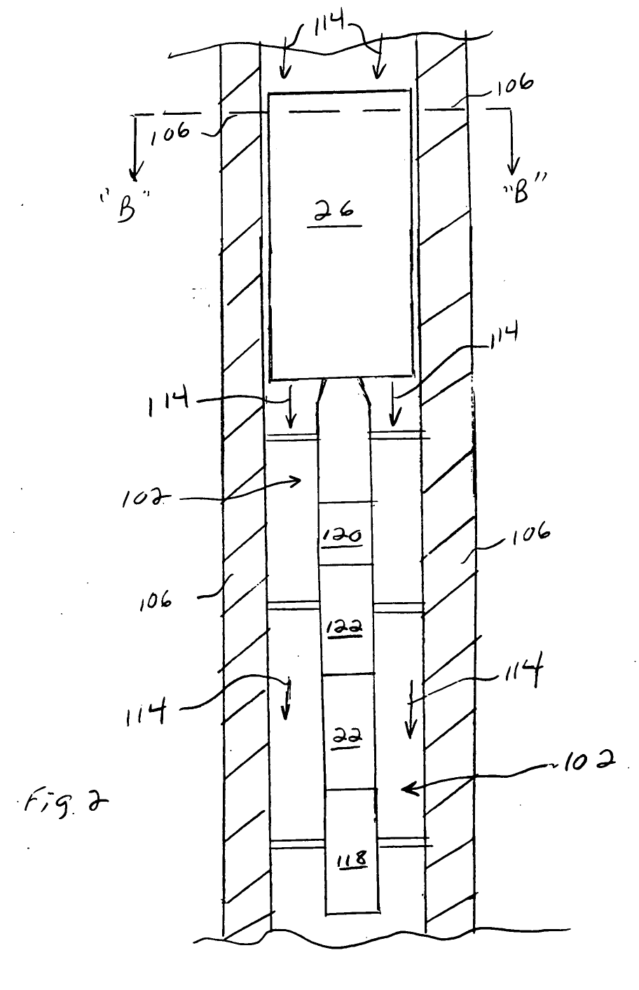

The bottom hole assembly 102 also comprises a sensing module 118 (see FIG. 2). The sensing module 118 is suspended within the drill collar 106, up-hole of the drill bit 104. The sensing module 118 can include directional sensors, such as magnetometers and accelerometers, that facilitate MWD operations. The sensing module 118 can also be equipped with sensors, such as gamma sensors, that facilitate LWD operations. These sensors can be included in addition to, or in lieu of the directional sensors. Other types of sensors also can be incorporated into the sensing module 118 or the drill collar wall, such as sensors used in conjunction with magnetic resonance imaging, gamma scintillators, nuclear detectors, etc.

Information collected by the sensing module 118 is transmitted to the surface for analysis using a mud-pulse telemetry system 20. The telemetry system 20 includes an encoder 22, a decoder 24, a pulser 26, and a pressure transducer 28 (see FIG. 2).

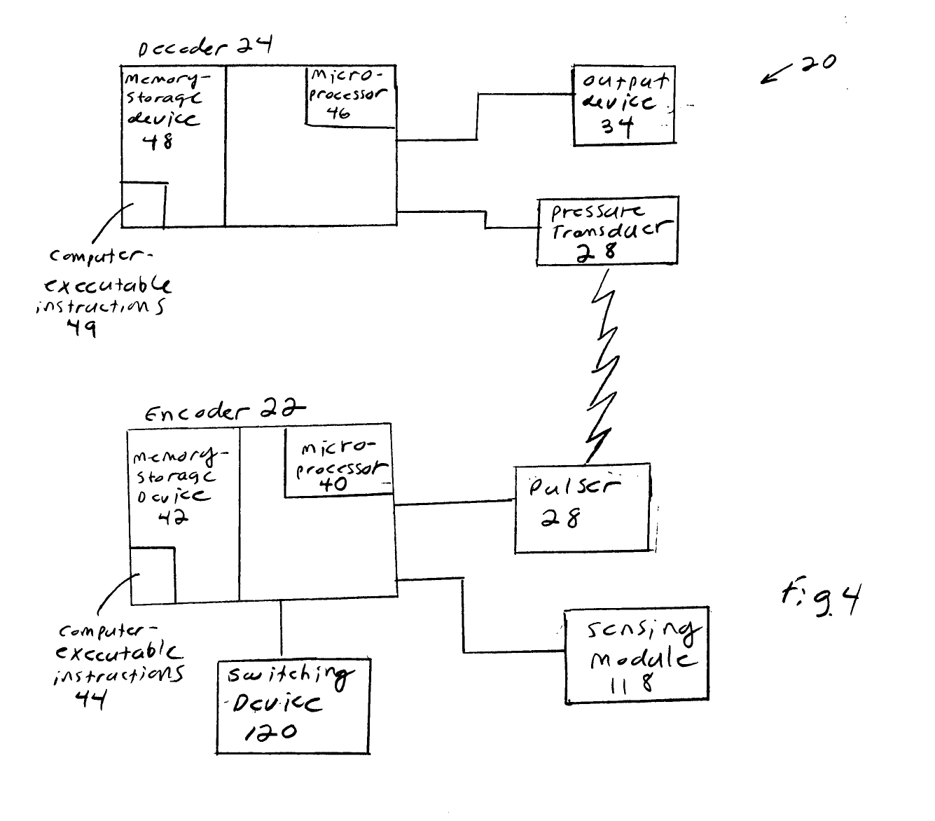

The encoder 22 and the pulser 26 form part of the bottom hole assembly 102. The encoder 22 and the pulser 26 are suspended within the drill collar 106, up-hole of the sensing module. The encoder 22 is communicatively coupled to the sensing module 118, and digitally encodes the sensor data output by the sensing module 118 (see FIG. 4). The encoder 22 can comprise a processor such as a microprocessor 40, and a memory storage device 42 communicatively coupled to the microprocessor 40. The encoder 22 also can include a set of computer-executable instructions 44 stored on the memory storage device 42.

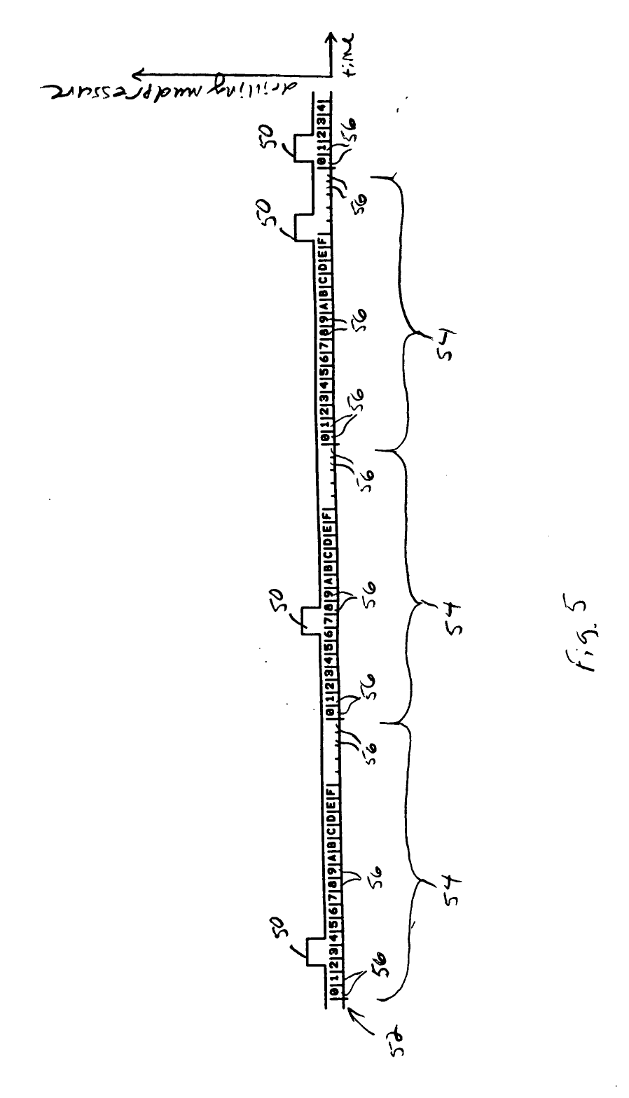

The pulser 26 is communicatively coupled to the encoder 22, and generates pressure pulses 50 in the column of drilling mud 114 being pumped down-hole through the drill collar 106. (The pulses 50 are depicted graphically in FIGS. 5-8.) The pulses 50 are generated in response to commands from the encoder 22. The pulses 50 are representative of the data collected by the sensing module 118, as discussed below.

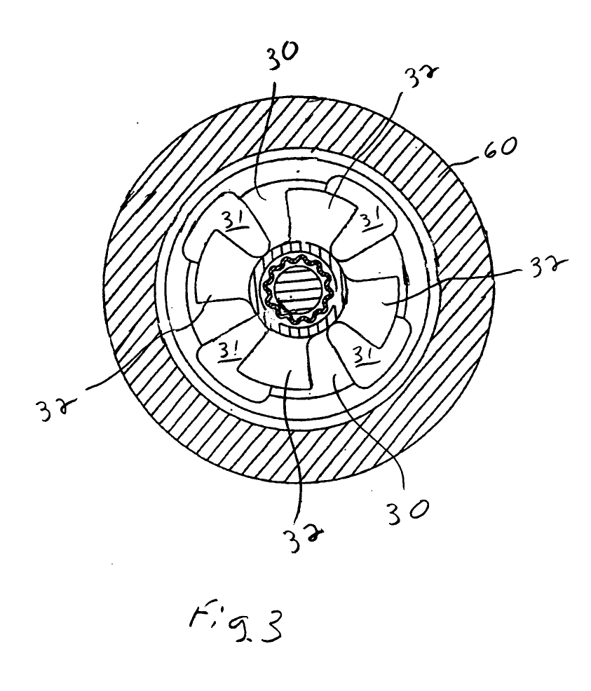

The pulser 26 can include a stator 30 that forms passages 31 through which the drilling mud 114 flows (see FIG. 3). The pulser 26 also can include a rotor 32 positioned upstream or downstream of the stator 30. The rotor 32 can be rotated continuously by the drilling mud 114. (This type of pulser is commonly referred to as a mud siren.) Alternatively, the rotor 32 can be rotated incrementally. The incremental movement can be achieved by oscillating the rotor 32, or by incrementally rotating the rotor 32 in one direction. The movement of the rotor 32 in relation to the stator 30 causes the blades of the rotor 32 to alternatively increase and decrease the degree to which the blades obstruct the stator passages 31, thereby generating pulses in the drilling mud 114. A suitable pulser 26 can be obtained, for example, from APS Technology, Inc. of Cromwell, Conn.

Pulsers suitable for use as part of the telemetry system 20 are described in U.S. Pat. No. 6,714,138 (Turner et al.), and U.S. application Ser. No. 10/888,312, filed Jul. 9, 2004 and titled “Improved Rotary Pulser for Transmitting Information to the Surface From a Drill String Down Hole in a Well.” Each of these documents is incorporated by reference herein in its entirety.

Other methods for generating pressure pulses include opening and closing a poppet valve, or opening a valve that permits some of the drilling mud to port from the center bore to the annulus between the drill collar and the well bore wall (thus generating a negative pressure pulse).

The pressure transducer 28 preferably is a strain-gauge pressure transducer. The pressure transducer 28 is located within the column of drilling mud 114, proximate the surface (see FIG. 1). The pulses 50 generated in the drilling mud 114 by the pulser 26 propagate up-hole through the drill string 100, and are sensed by the pressure transducer 28. The pressure transducer 28 generates an electrical output representative of the amplitude and duration of the pulses 50.

The pressure transducer 28 is communicatively coupled to the decoder 24 (see FIG. 4). The decoder 24 converts the output of the pressure transducer 28 into a format suitable for be analysis by the operators of the drilling rig, or other potential users of the data collected by the sensing module 118.

The decoder 24 can comprise a processor such as a microprocessor 46, and a memory storage device 48 communicatively coupled to the microprocessor 46 (see FIG. 4). The decoder 24 also can include a set of computer-executable instructions 49 stored on the memory storage device 48.

The telemetry system 20 can include one or more output devices 34 communicatively coupled to the decoder 24 (see FIGS. 2 and 4). The output device 34 can be configured to process, display, store, or transmit the output from the decoder 24. For example, the output device 34 can be a computing device, such as a personal computer, that facilitates monitoring of the data output by the decoder 24 on-site, on a real-time basis. Alternatively, the output of the decoder 24 can be transmitted for monitoring or storage off-site. Data transmission can be accomplished by any suitable means, such as wireless transmission, the internet, an intranet, etc.

The bottom hole assembly 102 can also include a switching device 120 that senses whether drilling mud 114 is being pumped through the drill string 100 (see FIGS. 2 and 4). The switching device 120 can be communicatively coupled to encoder 22. The computer-executable instructions 44 of the encoder 22 can be configured to store the data received from the sensing module 118 when drilling mud 114 is not being pumped, as indicated by the output of the switching device 120. The encoder 22 can initiate data transmission when the flow of drilling mud 114 resumes. A suitable switching device 120 can be obtained from APS Technology, Inc. as the FlowStat™ Electronically Activated Flow Switch.

The bottom hole assembly 102 can further comprise a battery 122 for powering the encoder 22, the pulser 26, the sensing device 118, and the switching device 120 (see FIG. 2). Alternatively, power can be supplied by a turbine-alternator assembly or other suitable power source.

The encoder 22 receives data from the sensing modules 16, as noted above. The computer-executable instructions 44 of the encoder 22 include algorithms that digitize the data from the sensor 16. The computer-executable instructions 44 preferably convert the data from the sensing module 118 into four-bit “nybbles.” Each nybble represents a hexadecimal digit. It should be noted that other formats for the digitized data can be used in the alternative.

The encoder 22 generates an output that controls the pulser 26. More specifically, the computer-executable instructions 44 generate commands that control the pulser 26. The commands are based on the digitized sensor data, i.e., on the four-bit nybbles generated in response to the data received from the sensing module 118. The commands cause the pulser 26 to generate the pulses 50.

The pulses 50 have a predetermined duration and amplitude that make the pulses suitable for detection by the pressure transducer 28. For example, each pulse 50 can have a duration of approximately 1.5 seconds, and an amplitude of approximately ten to approximately one-hundred pounds per square inch. Specific values for the duration and amplitude of the pulses 50 are provided for exemplary purposes only. Other values for each of these parameters can be used in alternative embodiments.

The encoder 22 synchronizes each pulse 50 with a time base 52 as shown, for example, in FIG. 5. The timing of each pulse 50 represents the value of the hexadecimal digit associated with that particular pulse 50.

The time base 52 is defined by a series of major time increments, hereinafter referred to as major divisions 54. Each major division 54 is divided into twenty-one discrete subdivisions or minor time increments, hereinafter referred to as time slots 56. One pulse 50 is produced within each major division 54 under normal operating conditions, as shown in FIG. 5. (More than one pulse 50 can be present within a major division 54 due to noise, as discussed below.)

The time slots 56 each have a duration of approximately 0.75 second. Each major division 54 therefore has a duration of approximately 15.75 seconds. It should be noted that specific values for the durations of the time slots 56 and the major divisions 54 are provided for exemplary purposes only. Other values for each of these parameters can be used in alternative embodiments.

The hexadecimal digit represented by a particular pulse 50 is determined by the location of the pulse 50 within its associated major division 54. In particular, the first ten time slots 56 in each major division 54 correspond respectively to the hexadecimal digits 0 through 9. The next six time slots 56 correspond respectively to the hexadecimal digits A through E.

The location of the beginning of a pulse 50 within the associated major division 54 determines the value of the nybble associated with that pulse 50. In particular, the encoder 22 times the pulse 50 so that the beginning of the pulse 50 occurs during the time slot 56 corresponding to the hexadecimal digit associated with that pulse 50. The start (leading edge) of each pulse 50 preferably is timed to occur at the approximate mid-point of the associated time slot 56.

The computer-executable instructions 44 time each pulse 50 based on the hexadecimal value of the preceding pulse 50, and the total number of time slots 56 in each major division 54. More specifically, the computer-executable instructions 44 determine the number of time slots 56 that separate the start of a particular pulse from the start of the preceding pulse, using the following calculation:

$$number of time slots between start of pulse and start of previous pulse = hexadecimal value of pulse + ( number of time slots per major division - hexadecimal value of previous pulse )$$

For example, the hexadecimal value of the pulses 50 that occur during the first and second major divisions 54 depicted in FIG. 5 are two and six, respectively. The number of time slots 56 between the respective starts of the two pulses 50 therefore equals (6+(21−2)), or twenty-five. The encoder 22 thus counts twenty-five time slots 56, i.e., the encoder 22 allows twenty-five time slots 56 to elapse after the start of the first pulse 50, before commanding the second pulse 50.

The hexadecimal value of the pulses 50 that occur during the second and third major divisions 54 depicted in FIG. 5 are six and fifteen (“F” in hexadecimal notation), respectively. The number of time slots 56 between the respective starts of the two pulses 50 therefore equals (15+(21−6)), or thirty. The encoder 22 therefore allows thirty time slots 56 to elapse between the respective starts of these pulses 50.

The hexadecimal value of the pulses 50 that occur during the third and fourth major divisions 54 depicted in FIG. 5 are fifteen and zero, respectively. The number of time slots 56 between the respective starts of the two pulses 50 therefore equals (0+(21−15)), or six.

The computer-executable instructions 49 of the decoder 24 are configured to decode the pulses 50 in a process substantially the reverse of that in which the pulses 50 are encoded by the encoder 22. In particular, the decoder 24 counts the number of time slots 56 that occur between successive pulses 50, based on the input from the pressure transducer 28. The decoder 24 determines the hexadecimal value of a particular pulse 50 based on the hexadecimal value of the preceding pulse 50 and the number of time slots 56 per major division 54, using the following calculation:

$$hexadecimal value of pulse = number of time slots between start of pulse and start of previous pulse - ( number of time slots per major division - hexadecimal value of previous pulse )$$

For example, the respective starts of the first and second pulses 50 depicted in FIG. 5 are separated by approximately twenty-five time slots 56. The hexadecimal value of the second pulse 50 therefore equals (25−(21−2)), or six. The decoder 24 therefore recognizes the second pulse 50 as representing the hexadecimal digit six.

The respective starts of the second and third pulses 50 depicted in FIG. 5 are separated by approximately thirty time slots 56. The hexadecimal value of the second pulse 50 therefore equals (30−(21−6)), or fifteen. The decoder 24 thus recognizes the third pulse 50 as representing the hexadecimal digit fifteen.

The respective starts of the third and fourth pulses 50 depicted in FIG. 5 are separated by approximately six time slots 56. The hexadecimal value of the second pulse 50 therefore equals (6−(21−15)), or zero. The decoder 24 thus recognizes the third pulse 50 as representing the hexadecimal digit zero.

The final five time slots 56 in each major division 54 do not correspond to a hexadecimal digit. In other words, each major division 54 includes five time slots 56, or a time period of approximately 4.25 seconds, at the end thereof during which no pulses 50 will be commanded. These time slots 56 are included to help ensure that the pulse 50 associated with each major division 54 does not extend into the following major division 54, and to help minimize interaction between successive pulses 50.

The duration of the above-noted time period during which a pulse 50 normally will not be commanded can be greater or less than 4.25 seconds in alternative embodiments. The duration of the time period should be greater than the duration of one pulse 50, and preferably is at least twice the duration of one pulse 50.

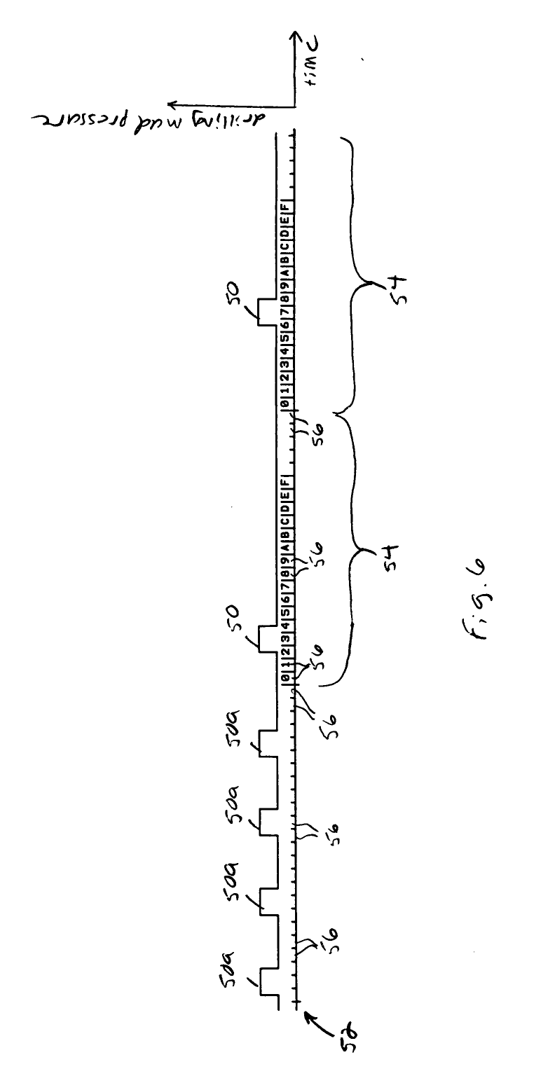

The initiation of a data-transmission sequence by the encoder 22 and the pulser 26 can be signaled by a predetermined combination of the pulses 50. These particular pulses 50 hereinafter are referred to as “synchronization pulses 50a,” and are depicted in FIG. 6.

For example, the start of a data-transmission sequence can be indicated by four synchronization pulses 50a, with the start of each of the second, third, and fourth synchronization pulses 50a spaced from the start of the preceding synchronization pulse 50a by approximately six of the time slots 56, or approximately 4.50 seconds. In other words, the four synchronization pulses 50a can be spaced apart by approximately two pulse widths, or 3.0 seconds.

The computer-executable instructions 44 of the encoder 22 begin the time base 44 after a predetermined interval has elapsed following the start of the fourth synchronization pulse 50a. In particular, the computer-executable instructions 44 treat the fourth synchronization pulse 56 as corresponding to the hexadecimal digit fifteen. In other words, the computer-executable instructions 44 count approximately five and one-half time slots 56 between the start of the fourth synchronization pulse 56 and start of the first major division 54.

For example, in the sequence depicted in FIG. 6, the corresponding hexadecimal value of the pulse 50 in the first of the major divisions 54 is two. The computer-executable instructions 44 therefore count (2+(21−15)), or eight time slots 56 between commanding the fourth synchronization pulse 50a, and the pulse 50 in the first major division 54.

The computer-executable instructions 49 of the decoder 24 include algorithms that recognize the above-described sequence of synchronization pulses 50. Moreover, the computer-executable instructions 49 recognize that the first time slot 56 of the first major division 54 begins approximately five and one-half time slots 56 after the start of the fourth synchronization pulse 50a.

For example, in the sequence depicted in FIG. 6, the computer-executable instructions 49 recognize the occurrence of four pulses 50 spaced apart by approximately two pulse widths as an indication that a data-transmission sequence is about to begin. The computer-executable instructions 49 count the number of time slots 56 that occur between the start of the fourth synchronization pulse 56 and them subsequent pulse 50 (eight time slots 56, in this example). The computer-executable instructions 49 determine the hexadecimal value represented by the pulse 50 occurring during the first major division 54 as (8−(21−15)), or two.

The synchronization pulses 50a thus facilitate synchronization of the decoder 24 with the time base 52 generated by the encoder 22. In other words, the synchronization pulses 50a make it possible for the decoder 24 to reference the same time base 52 as the encoder 22. This is necessary because, as discussed above, the pulses 50 representing data from the sensing module 118 are encoded with reference to the time base 52.

It should be noted that other sequences of synchronization pulses 50a can be used in the alternative, provided the sequence is one that normally does not occur during data transmission.

For example, more or less than four of the synchronization pulses 50a can be used in alternative embodiments. Moreover, the interval between the start of the final synchronization pulse 50a and the subsequent major division 54 can be greater or less than approximately five and one-half time slots 56 in alternative embodiments. The interval should be long enough to permit the final synchronization pulse 50a to end before the start of the subsequent major division 54. The interval should be sufficiently short, however, to reduce the potential for noise to occur during the interval.

Each data-transmission sequence transmitted from the encoder 22 to the surface normally includes information indicating the duration of the sequence. Hence, a sequence of pulses 50 indicating the end of the data-transmission sequence normally is not necessary. If desired, however, the encoder 22 can be programmed to command, and the decoder 24 can be programmed to recognize such a sequence.

The decoder 24 can be configured to recognize and disregard noise that is detected by the pressure transducer 28. Noise can occur due to factors such as oscillations in the supply pressure of the drilling mud 114, vibrations caused by the drilling operation, etc.

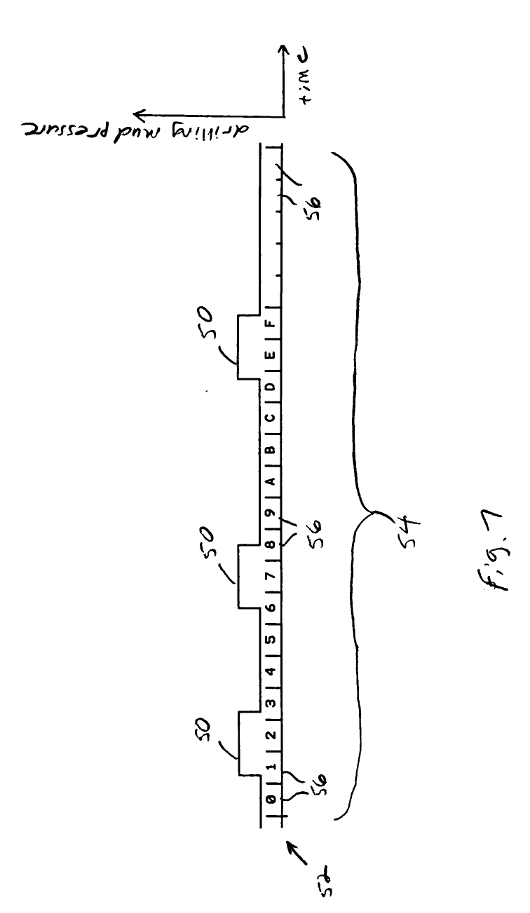

The encoder 22 normally commands only one pulse 50 within each major division 56 during a data-transmission sequence, as discussed above. Thus, the presence of more than one pulse 50 within a major division 54 usually is the result of noise (see, for example, FIG. 7).

Each pulse 50 commanded by the encoder 22 preferably starts at the approximate mid-point of the associated time slot 56, as noted above. The computer-executable instructions 49 of the decoder 24, upon recognizing that two or more pulses 50 were detected within one major division 54, determines which of the pulses 50 has a start closest to the mid-point of its corresponding time slot 56. The pulse 50 having its start closest to the mid-point is considered the valid pulse 50, i.e., the pulse 50 that does not represent noise. The other pulse or pulses 50 are considered noise, and are disregarded.

For example, FIG. 7 depicts a major division 54 with three pulses 50 occurring therein. The first pulse 50 begins relatively close to the beginning of the second time slot 56, and the third pulse 50 begins relatively close to the end of the fourteenth time slot 56. Of the three pulses, the second pulse 50 begins closest to the mid-point of its associated time slot 56. The second pulse 50 therefore is considered the valid pulse 50. The validity of this pulse 50, however, cannot be determined with absolute certainty. Hence, the computer-executable instructions 49 preferably flag the data associated with the pulse 50, to indicate that the validity of the data is questionable.

The encoder 22 normally does not command pulses 50 within the final five time slots 56 of a major division 54. The computer-executable instructions 49 of the decoder 24 can be configured to recognize pulses 50 that start in any of these time slots 56 as noise.

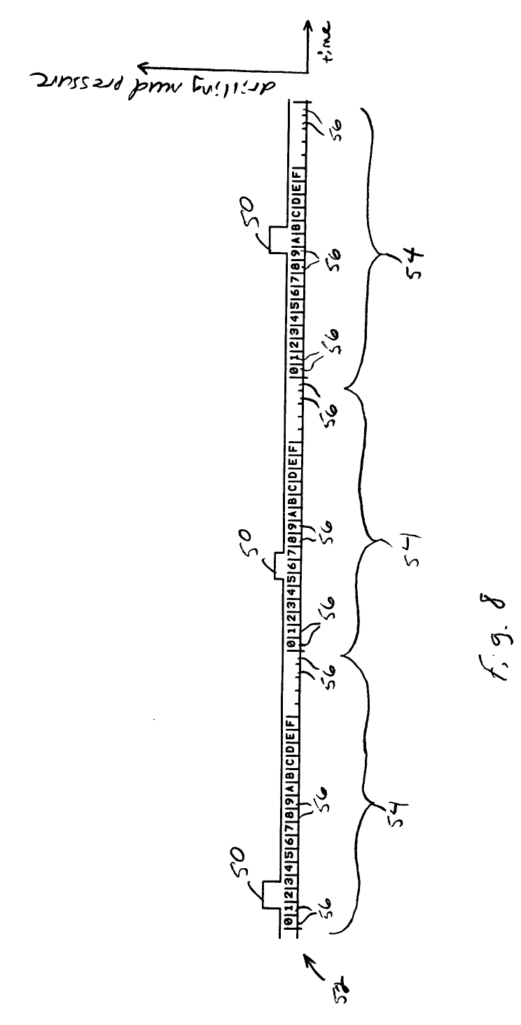

The decoder 24 can be configured to maintain its synchronization with the time base 52 when pulses 50 are not detected in one or more of the time slots 56. In other words, the decoder 24 can recognize that pulses 50 are missing or attenuated in a major division 54. An “attenuated” pulse 50 refers to a pulse 50 having an amplitude or duration that is insufficient to facilitate detection of the pulse 50 by the pressure transducer 52. An attenuated pulse 50 is depicted, for example, in the second major division 54 shown in FIG. 8.

Missing or attenuated pulses 50 can occur, for example, when the rotor 32 of the pulser 26 does not sufficiently block the stator passages 31 of the pulser 26 to provide the requisite back pressure in the drilling mud 114. Missing or attenuated pulses 50 also can result, for example, from fluctuations in the supply pressure of the drilling mud 114, or from vibrations caused by the drilling operation. The computer executable instructions 49 of the decoder 24 can be configured to recognize a missing or attenuated pulse 50 as follows.

The computer-executable instructions 49 count the number of time slots 56 that elapse between successive detected pulses 50, as discussed above. The computer-executable instructions 49 calculate the hexadecimal digit encoded in the second detected pulse 50 based on the number of time slots 56 counted, the hexadecimal value associated with the previous (first) detected pulse 50, and the number of time slots 56 in each major division 54.

The calculated value for the hexadecimal digit encoded in the second detected pulse 50 will lie in the range of twenty-one to thirty-six, when the first and second detected pulses 50 are separated by a major division 54 in which a pulse 50 is not detected. The calculated value lies within this range because of the twenty-one additional time slots 56 associated with the major division 54 in which no pulse 50 is detected. In other words, the major division 54 in which a pulse 50 is not detected introduces a twenty-one count offset in the number of time slots 56 counted between the respective starts of the first and second pulses 50.

The computer-executable instructions 49 can be configured to recognize that a hexadecimal digit within the range of twenty-one to thirty-six indicates that a pulse 50 has not been detected in the previous major division 54. The computer-executable instructions 49 can subtract fifteen from the calculated value, to arrive at what should be the correct value for the hexadecimal digit associated with the second detected pulse 50.

The computer-executable instructions 49 can set the value of the data associated with the missing pulse 50 to zero, and can flag that particular piece of data to indicate that the validity thereof is questionable.

For example, FIG. 8 depicts three major divisions 54. The pulse 50 depicted in the second of the major divisions 54 is attenuated. More specifically, the pulse 50 has an amplitude insufficient to facilitate detection of the pulse 50 by the pressure transducer 52. The decoder 24 therefore counts fifty time slots 56 between the points at which the first and third pulses 50 are detected.

The computer-executable instructions 49 calculate the hexadecimal value for the third pulse 50 as (50−(21−1)), or thirty. Because thirty is within the range of twenty-one to thirty-six, the computer-executable instructions 49 recognize that a pulse 50 was not detected in the previous major division 56. The computer-executable instructions 49 therefore subtract twenty-one from the calculated value of thirty, to arrive at the correct hexadecimal value of nine for the third pulse 50. The computer-executable instructions 49 also set the value of the data associated with the second major division 54 to zero, and flag this data as questionable.

The computer-executable instructions 49 can be configured to recognize when a pulse 50 is not detected in two or more successive major divisions 54, using the above technique. For example, two successive major divisions 54 in which no pulse is detected will produce an offset of forty-two in the value of the calculated hexadecimal digit detected subsequently. This offset will cause the time-slot count to lie within a range of forty-two to fifty-seven when the subsequent pulse 50 is detected. The computer-executable instructions 49 can subtract the offset of forty-two from the calculated hexadecimal value for the detected pulse 50, to arrive at what should be the correct value.

Alternatively, the computer-executable instructions 49 can be configured to interpret two or more successive major divisions 54 in which a pulse 50 is not detected as an indication that the input signal to the decoder 24 has been lost, and that no further data processing should take place until the next set of synchronization pulses 50a are received.

The ability of the telemetry system 20 to recognize and identify spurious pulses 50, and to continue decoding transmitted data when pulses 50 are missing or attenuated, it is believed, can significantly increase the accuracy of the information transmitted between the sensing module 118 and the surface. Hence, the operators of the drilling rig (or other users of the information) can be provided with a more accurate indication of, for example, the direction of travel of the drill bit 104 during measurement wile drilling operations, or the characteristics of the earthen formation 110 during logging while drilling operations.

Moreover, the faulted or missing information can be factored out automatically, on a real-time basis, thereby minimizing or eliminating the potential for the faulted or missing information to adversely affect the progress of drilling operations.

The foregoing description is provided for the purpose of explanation and is not to be construed as limiting the invention. While the invention has been described with reference to preferred embodiments or preferred methods, it is understood that the words which have been used herein are words of description and illustration, rather than words of limitation. Furthermore, although the invention has been described herein with reference to particular structure, methods, and embodiments, the invention is not intended to be limited to the particulars disclosed herein, as the invention extends to all structures, methods and uses that are within the scope of the appended claims. Those skilled in the relevant art, having the benefit of the teachings of this specification, may effect numerous modifications to the invention as described herein, and changes may be made without departing from the scope and spirit of the invention as defined by the appended claims.

For example, although a preferred method and system have been described in connection with a mud-pulse telemetry system, the principles of the inventions can be applied to data-transmission techniques that use fluids other than drilling mud as the transmission medium.

What is claimed:

1. A method for transmitting information using mud-pulse telemetry, comprising:
generating a time base comprising a plurality of time increments;
generating a first and a second pressure pulse at a first location in a column of drilling mud;
counting the number of the time increments;
detecting the first and the second pressure pulses at a second location in the column of drilling mud; and
correlating the second pressure pulse with a numerical value based on the number of the time increments that elapse between the detection of the first and the second pressure pulses.

2. The method of claim 1, wherein correlating the second pressure pulse with a numerical value based on the number of the time increments that elapse between the detection of the first and the second pressure pulses comprises correlating the second pressure pulse with a hexadecimal digit.

3. The method of claim 1, wherein generating a time base comprising a plurality of predetermined time increments further comprises generating a first major time increment comprising a first plurality of minor time increments, and a second major time increment comprising a second plurality of the minor time increments.

4. The method of claim 3, wherein generating a first and a second pressure pulse at a first location in a column of drilling mud comprises generating the first pressure pulse during the first major time increment and generating the second pressure pulse during the second major time increment.

5. The method of claim 3, wherein:
counting the number of the time increments comprises counting the number of the minor time increments; and
correlating the second pressure pulse with a numerical value based on the number of the time increments that elapse between the detection of the first and the second pressure pulses comprises correlating the second pressure pulse with a numerical value based on the number of the minor time increments that elapse between the detection of the first and the second pressure pulses.

6. The method of claim 3, wherein a first nine of the minor time increments in each of the first and second major time increments correspond respectively to hexadecimal digits zero through nine, and a subsequent six of the minor time increments in each of the first and second major time increments correspond respectively to hexadecimal digits A through F.

7. The method of claim 6, wherein each of the first and the second major time increments includes five of the minor time increments following the six of the minor time increments corresponding respectively to hexadecimal digits A through F.

8. The method of claim 5, wherein correlating the second pressure pulse with a numerical value based on the number of the minor time increments that elapse between the detection of the first and the second pressure pulses comprises correlating the second pressure pulse with a numerical value based on the number of the minor time increments that elapse between detection of the respective starts of the first and the second pressure pulses.

9. The method of claim 3, further comprising signaling the start of transmittal of the information by generating a predetermined sequence of pressure pulses prior to the first major time increment.

10. The method of claim 9, wherein the predetermined sequence of pressure pulses is four of the pressure pulses spaced apart by approximately two pulse widths.

11. The method of claim 3, further comprising detecting a third pressure pulse during the second major time increment and identifying the third pressure pulse as noise based on a predetermined criterion.

12. The method of claim 11, wherein the predetermined criterion comprises determining which of the second and third pulses has a start time closer to a mid-point of the respective minor time increments during which the second and the third pulses are detected.

13. The method of claim 3, further comprising identifying a third major time increment in which no pressure pulse is detected in accordance with a predetermined criterion, the third major time increment occurring between the first and second major time increments.

14. The method of claim 13, wherein the predetermined criterion is whether the number of the minor time increments between the first and the second pressure pulses equals or exceeds a predetermined value.

15. The method of claim 14, wherein the predetermined value is equal to the number of the minor time increments in each of the first and the second major time increments.

16. The method of claim 1, wherein:
generating a first and a second pressure pulse at a first location in a column of drilling mud comprises generating the first and second pressure pulses at a location at or near a down-hole end of a bore; and
detecting the first and the second pressure pulses at a second location in the column of drilling mud comprises detecting the first and the second pressure pulses at a location at or near the surface.

17. The method of claim 1, wherein detecting the first and the second pressure pulses at a second location in the column of drilling mud comprises measuring a pressure of the column of drilling mud at the second location.

18. The method of claim 1, wherein generating a first and a second pressure pulse at a first location in a column of drilling mud comprises restricting a flow area of the drilling mud to cause back pressure in the column of drilling mud.

19. The method of claim 1, further comprising digitizing information from a sensor and encoding the digitized information in the second pressure pulse.

20. The method of claim 19, wherein encoding the digitized information in the second pressure pulse comprises correlating the digitized information with one of the time increments corresponding to the digitized information.

21. The method of claim 20, further comprising timing the start of the second pressure pulse with the one of the time increments corresponding to the digitized information.

22. The method of claim 20, further comprising determining the one of the time increments corresponding to the digitized information based on the time increment corresponding to the first pressure pulse and digitized information encoded in the first pressure pulse.

23. The method of claim 3, wherein correlating the second pressure pulse with a numerical value based on the number of the time increments that elapse between the detection of the first and the second pressure pulses comprises calculating a difference between the number of the minor time increments in each of the first and second major time increments and a numerical value correlated with the first pressure pulse; and subtracting the difference from the number of the minor time increments that elapse between the detection of the first and the second pressure pulses.

24. The method of claim 3, further comprising generating the second pressure pulse a predetermined amount of time after the first pressure pulse, and determining the predetermined amount of time by calculating a difference between the number of the minor time increments in each of the first and second major time increments to a numerical value correlated with the first pressure pulse; and adding the difference to the numerical value to be correlated with of the second pressure pulse.

25. A method for transmitting digital information through a fluid medium, comprising:
generating a first and a second pressure pulse in the fluid medium;
encoding the digital information in the second pressure pulse by generating the second pressure pulse a predetermined amount of time after generating the first pressure pulse;
sensing the first and the second pressure pulses; and
decoding the digital information by determining the elapsed time between the first pressure pulse and the second pressure pulse.

26. The method of claim 25, wherein decoding the digital information further comprises decoding the digital information based on digital information encoded in the first pressure pulse.

27. The method of claim 26, further comprising generating a time base comprising a plurality of time increments and determining the elapsed time between the first pressure pulse and the second pressure pulse comprises counting the time increments between detection of the first and the second pressure pulses.

28. The method of claim 27, wherein the plurality of time increments are minor time increments and the time base further comprises a plurality of major time increments each comprising a predetermined number of the minor time increments, the first pressure pulse occurs during a first of the major time increments, and the second pressure pulse occurs during a second of the major time increments.

29. The method of claim 28, wherein determining the elapsed time between the first pressure pulse and the second pressure pulse comprises counting the number of the minor time increments between the first and the second pressure pulses.

30. The method of claim 29, wherein counting the number of the minor time increments between the first and the second minor time increments comprises counting the number of the minor time increments between the respective starts of first and the second pressure pulses.

31. The method of claim 29, wherein decoding the digital information further comprises calculating a difference between the predetermined number of the minor time increments in each of the major divisions and the digital information encoded in the first pressure pulse; and subtracting the difference from the number of the minor time increments between the first and the second pressure pulses.

32. The method of claim 29, further comprising determining the predetermined amount of time after generating the first pressure pulse by calculating a difference between the number of the minor time increments in each of the major divisions to the digital value of the first pressure pulse; and adding the difference to the digital value of the second pressure pulse.

33. The method of claim 28, further comprising signaling the start of transmission of the digital information by generating a predetermined sequence of pressure pulses prior to the first major division.

34. The method of claim 28, further comprising detecting a third pressure pulse during the second major time increment and identifying the third pressure pulse as noise based on a predetermined criterion.

35. The method of claim 34, wherein the predetermined criterion comprises determining which of the second and third pulses has a start time closer to a mid-point of the respective minor time increments during which the second and the third pulses are sensed.

36. The method of claim 28, further comprising identifying a third major time increment in which no pressure pulse is detected in accordance with a predetermined criterion, the third major time increment occurring between the first and second major time increments.

37. The method of claim 36, wherein the predetermined criterion is whether the number of the minor time increments between the first and the second pressure pulses equals or exceeds a predetermined value.

38. The method of claim 37, wherein the predetermined value is equal to the number of the predetermined number of the minor time increments in each of the first and the second major time increments.

39. A method for sending information through a fluid medium, comprising:
generating a succession of pressure pulses in the fluid medium;
timing the pressure pulses so that successive ones of the pressure pulses are spaced apart by respective predetermined time intervals;
detecting the pressure pulses; and
determining a digital value corresponding to each of the pressure pulses based on the predetermined time interval between the pressure pulse and the previous pressure pulse, and the digital value of the previous pulse.

40. The method of claim 39, wherein determining a digital value corresponding to each of the pressure pulses based on the predetermined time interval between the pressure pulse and the previous pressure pulse, and the digital value of the previous pulse comprises determining a hexadecimal value corresponding to each of the pressure pulses based on the predetermined time interval between the pressure pulse and the previous pressure pulse, and the hexadecimal value of the previous pulse.

41. A system for transmitting information using mud-pulse telemetry, comprising:
an encoder comprising a processor, a memory-storage device communicatively coupled to the processor, and a set of computer-executable instructions stored on the memory-storage device, the encoder generating a time base comprising a plurality of time increments;
a pulser communicatively coupled to the encoder for generating a first and a second pressure pulse at a first location in a column of drilling mud in response to inputs from the encoder;
a sensor for detecting the first and the second pressure pulses at a second location in the column of drilling mud; and
a decoder communicatively coupled to the sensor and comprising a processor, a memory-storage device communicatively coupled to the processor, and a set of computer-executable instructions stored on the memory-storage device, the decoder counting the number of the time increments and correlating the second pressure pulse with a numerical value based on the number of the time increments that elapse between the detection of the first and the second pressure pulses.

42. The system of claim 41, wherein the time base comprises a first major time increment comprising a first plurality of minor time increments, and a second major time increment comprising a second plurality of the minor time increments.

43. The system of claim 41, wherein the decoder can identify a third pressure pulse detected during the second major time increment as noise based on a predetermined criterion.

44. The system of claim 43, wherein the predetermined criterion comprises determining which of the second and third pulses has a start time closer to a mid-point of the respective minor time increments during which the second and the third pulses are detected.

45. The method of claim 41, wherein the decoder can identify a third major time increment in which no pressure pulse is detected in accordance with a predetermined criterion, the third major time increment occurring between the first and second major time increments.

46. The system of claim 45, wherein the predetermined criterion is whether the number of the minor time increments between the first and the second pressure pulses equals or exceeds a predetermined value.

47. The system of claim 46, wherein the predetermined value is equal to the number of the minor time increments in each of the first and the second major time increments.
